(19) United States
(12) Patent Application Publication
(10) Pub. No.: US 2021/0351919 A1
(43) Pub. Date: Nov. 11, 2021

(54) A SYSTEM AND METHOD FOR BINDING INFORMATION TO A TANGIBLE OBJECT

(71) Applicant: GMKW TECHNOLOGY WUXI CO., LTD., Wuxi (CN)

(72) Inventors: Hua Liu, Wuxi (CN); Qiaxin GUO, Wuxi (CN); Thomas McGregor, Wuxi (CN)

(21) Appl. No.: 17/277,327

(22) PCT Filed: Sep. 19, 2019
(86) PCT No.: PCT/CN2019/106594

§ 371 Date: Mar. 18, 2021

(30) Foreign Application Priority Data
Sep. 20, 2018 (AU) 2018903537

(51) Int. Cl. H04L 9/08; H04L 9/30; H04L 9/32

(52) U.S. Cl. CPC H04L 9/0825; H04L 9/0866; H04L 9/3271; H04L 9/3247; H04L 9/3066

(57) ABSTRACT

Disclosed herein is a method for binding information to a tangible object, a method for verifying information bound to a tangible object, a method for verifying that an optical symbol fixed to a tangible object was optically read, a system for binding information to a tangible object, and a system for verifying information bound to a tangible object.

### TECHNICAL FIELD

The disclosure herein generally relates to a method for binding information to a tangible object, a method for verifying information bound to a tangible object, a method of determining where an object is scanned at, a system for binding information to a tangible object, and a method for verifying that an optical symbol fixed to a tangible object was optically read.

### BACKGROUND

Information associated with a tangible object can be important. FIG. 1 shows representations of examples of tangible objects, which include but are not limited to a certificate 1, a passport 2, a package for example a pharmaceutical package 3, a device 5 (examples of which include but are not limited to a tool, machine, weapon, or ammunition), materials 6, bank notes 7 and labels 8, polymer identification cards, polymer credit card, jewellery, and seals on devices including meters.

Examples of important information associated with a tangible object include educational grade information on a certificate, identity information on a passport, expiry date information on a pharmaceutical package, device certification, device service history, device use history, device ownership history, and the engineering specifications of a piece of engineering steel.

A person may wish to dishonestly tamper with grade information on a certificate or forge a certificate or identity document for advantage. Similarly, a counterfeiter may put a false expiry date on counterfeit pharmaceutical packaging, falsify a device certification, or make a length of engineering steel out of a lower grade of steel than claimed.

Consequently, it may be desirable to be able to verify that information associated with an object is correct.

### SUMMARY

Disclosed herein is a method for binding information to a tangible object. The method comprises retrieving an object identifier indicative of the identity of the tangible object by optically reading, with an optical symbol reader having preloaded therein an authority identifier indicative of the authority providing the information, a symbol fixed to the tangible object and encoding the object identifier. The method comprises generating private key information with a key derivation algorithm, the object identifier and the authority identifier, the private key information being exclusive to the pairing of the authority identifier and the object identifier. The method comprises generating public key information with a public key derivation algorithm and the private key information, the public key information being exclusive to the pairing of the authority identifier and the object identifier. The method comprises generating digital signature information for the information with a digital signature generation algorithm and the public key information. The method comprises sending the public key information, the digital signature information and the information to a data store, whereby the public key information, the digital signature information and the information is associated therein.

An embodiment comprises processing authority provided information with a hash function to generate the information.

An embodiment comprises the step of associating the public key information, the information bound to the object and the digital signature in a data store.

An embodiment comprises the step of sending the public key information to an authority associated with the optical symbol reader.

In an embodiment, the public key derivation algorithm uses elliptic curve cryptography.

In an embodiment, the public key derivation algorithm comprises a hash algorithm.

In an embodiment, the public key information is associated with public key information metadata.

An embodiment comprises applying to the object the information bound to the object.

In an embodiment, the object identifier, and authority identifier each comprises a respective sequence of symbols.

In an embodiment, the optical symbol reader comprises a processor and optical apparatus in communication with the processor, wherein the key derivation algorithm is executed in the processor.

In an embodiment, the optical symbol reader is a peripheral.

In an embodiment, the symbol comprises a luminescent symbol.

In an embodiment, the optical symbol is exclusive to the tangible object.

Disclosed herein is a method for verifying information bound to a tangible object. The method comprises the step of receiving the information bound to the tangible object. The method comprises the step of receiving a digital signature generated by a method in accordance with the above disclosure. The method comprises receiving the public key information used to generate the digital signature. The method comprises verifying that the data bound to the tangible object, the digital signature, and the public key information match.

An embodiment comprises capturing the data bound to the tangible object by digital imaging.

Disclosed herein is a method for verifying that an optical symbol fixed to a tangible object was optically read. The method comprises, with an optical symbol reader having preloaded therein an authority identifier indicative of the authority providing the information, retrieving an object identifier indicative of the identity of the tangible object by optically reading a symbol fixed to the tangible object and encoding the object identifier. The method comprises, within the optical reader, generating private key information with a key derivation algorithm, the object identifier and the authority identifier, the private key information being exclusive to the pairing of the authority identifier and the object identifier. The method comprises within the optical reader, generating public key information with a public key derivation algorithm and the private key information, the public key information being exclusive to the pairing of the authority identifier and the object identifier. The method comprises sending a message indicative of the symbol having been optically read and comprising the public key information to a server. The method comprises authenticating the message indicative of the symbol having been optically read with cryptographic challenge-response authentication using the private key information and the public key information.

Disclosed herein is a system for binding information to a tangible object. The system comprises an optical symbol reader. The optical symbol reader comprises an optical apparatus configured to generate symbol image information by imaging a symbol encoding object identifier and fixed to the tangible object. The system comprises a processor. The processor comprises memory having preloaded therein an authority identifier. The processor is configured to receive the symbol image information and retrieve the object identifier from the symbol image information so imaged. The processor is configured to combine the object identifier and the authority identifier with a key derivation algorithm and so generate private key information that is exclusive to the pairing of the authority identifier and the object identifier. The processor is configured to generate public key information with a public key derivation algorithm and the private key information, the public key information being exclusive to the pairing of the authority identifier and the object identifier. The processor is configured to generate digital signature information for the information with a digital signature generation algorithm and the public key information. The processor is configured to send the public key information, the digital signature information and the information to a data store, whereby the public key information, the digital signature information and the information is associated therein.

Disclosed herein is a system for verifying information bound to a tangible object. The system comprises a computer network interface for receiving the information bound to the tangible object. The system comprises a digital signature generated by a method in accordance with the above disclosure, and public key information used to generate the digital signature. The system comprises a processor configured to verify that the data bound to the tangible object, the digital signature, and the public key information match.

Disclosed herein is non-transitory processor readable tangible media including program instructions which when executed by a processor causes the processor to perform a method disclosed above.

Disclosed herein is a computer program for instructing a processor, which when executed by the processor causes the processor to perform a method disclosed above.

Any of the various features of each of the above disclosures, and of the various features of the embodiments described below, can be combined as suitable and desired.

### BRIEF DESCRIPTION OF DRAWINGS

Embodiments will now be described by way of example only with reference to the accompanying drawings in which:

FIG. 1 shows representations of example tangible objects.

FIG. 2 shows a flow chart of an embodiment of a method for binding information to a tangible object.

FIG. 3 shows a schematic diagram of an example of an optical symbol reader connected to a network to which an example server is also connected.

FIG. 4 shows a perspective view of an example of an optical apparatus, being of the optical symbol reader of FIG. 3.

FIG. 5 shows an example of a piece of engineering steel with an example of a public key applied thereto.

FIG. 6 shows a block diagram of an example of binding information to a document.

FIG. 7 shows a flow chart showing steps of an embodiment of a method for verifying information bound to a tangible object.

FIG. 8 shows a schematic diagram representing the structure of an example of a symbol in the form of a luminescent symbol.

### DETAILED DESCRIPTION

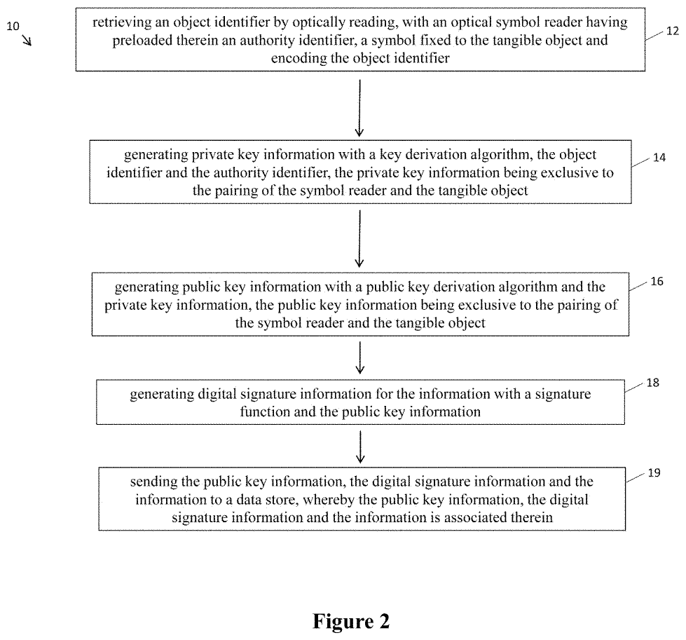

FIG. 2 is a flow chart showing steps of an embodiment of a method for binding information to a tangible object, the flow chart being generally indicated by the numeral 10. A step 12 comprises retrieving an object identifier in the form of a sequence of symbols by optically reading, with an optical symbol reader having preloaded therein an authority identifier in the form of a sequence of symbols, a symbol fixed to the tangible object and encoding the object identifier. The symbol comprises, in this but not all embodiments, a luminescent symbol that is optically readable by the optical symbol reader. The optical symbol may be unique to the tangible object. A step 14 comprises generating private key information with a key derivation algorithm, the object identifier and the authority identifier, the private key information being exclusive to the pairing of the authority identifier and the object identifier. A step 16 comprises generating public key information with a public key derivation algorithm and the private key information, the public key information being exclusive to the pairing of the authority identifier and the object identifier. A step 18 comprises generating digital signature information for the information to be bound to the tangible object with a digital signature generation algorithm and the public key information. A step 19 comprises sending the public key information, the digital signature information and the information to a data store, whereby the public key information, the digital signature information and the information is associated therein.

Generally, each authority may have a unique authority identifier and/or each object may have a unique object identifier. The public key and the private key are consequently exclusive to the pairing of the authority and the object. The authority may have a plurality of optical symbol readers having preloaded therein the authority identifier. Different authorities generally may have different authority identifiers. Alternatively, an authority may have only a single optical symbol reader. An authority may, however, have a plurality of authority identifiers and the plurality of identifiers may be preloaded in the plurality of optical symbol readers.

In this but not all embodiments, the authority provides authority provided information that is processed with a hash algorithm in the form of SHA256 to generate the information (“hash information”), which is a hash of the authority provided information. The authority provided information may be structured (e.g. a record data structure comprising fields of data) prior to processing with the hash algorithm. A Merkle tree comprising the structured information may be generated and the hash algorithm applied to the Merkle tree, generating root hash information. The hash algorithm may be applied because the digital signature algorithm does not assume that the input information is hash information. The purpose of the Merkle tree is to generate a root hash which is a fingerprint of the information, wherein the information is organised according to rules such that another entity using the same rules will obtain the same root hash. The Merkle tree enables determination of which specific data field is modified without needing to query all the original information. The authority provided information may, for example, comprise educational grades, the identity of a person, pharmaceutical expiry date information, or generally any suitable information held by an authority.

Because the public key information is exclusive to the pairing of the authority identifier and the object identifier, the public key information is a unique ID for the tangible object and may be used to identify the tangible object and to record the tangible object in a data store. The private key derivation function is a password based key derivation function (PBKDF2 in open SSL library), however any suitable private key derivation function may be used. Generally, but not necessarily, the symbol is in a form that is difficult to make, reproduce and read without highly specialised equipment in order to improve the security and integrity.

It is generally desirable to keep the authority identifier secret so that another person cannot impersonate the authority. It may be desirable to keep the object identifier secret. At least one of the authority identifier and the object identifier should be kept secret.

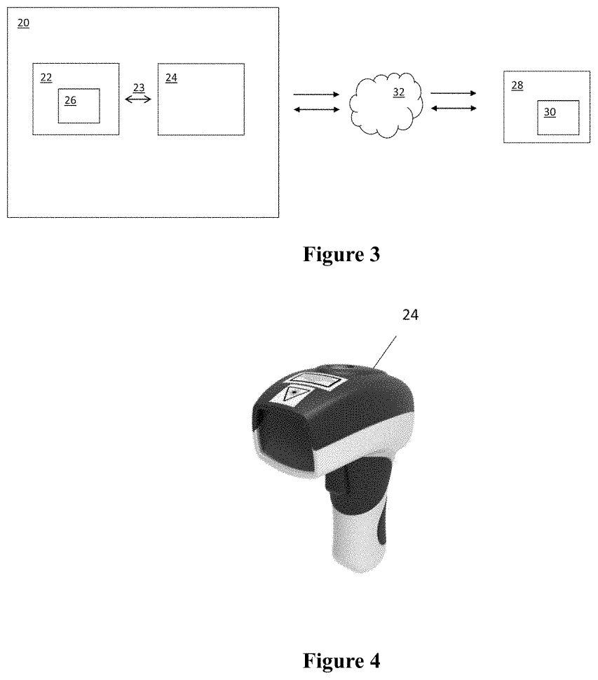

FIG. 3 shows a schematic diagram of an example of an optical symbol reader 20 used with the method 10. The optical symbol reader 20 is connected to a network 32 to which another processor 28 in the form of a remote server, block chain node, or generally any suitable processor is also connected. The optical symbol reader 20 comprises a processor 22 and optical apparatus 24 in communication with the processor 22. The processor comprises processor readable tangible media 26 including program instructions which when executed by the processor 22 causes the processor 22 to execute step 14 of generating the private key information, execute step 16 of generating public key information, and execute step 18 of generating a digital signature information, and execute the step 19 of sending the public key information, the digital signature information and the information to a data store. The public key (which is a unique identification for the tangible object) is used to digitally sign the information that an issuer (for example the Authority) wants to bind to the tangible object. The digital signature can be registered and used to prove that the information is bound to object.

FIG. 4 shows a perspective view of the optical apparatus 24, which has a pistol-grip configuration for hand-held operation by a user in the form of an agent of the authority. The optical apparatus 24 has a lens configured to image the luminescent symbol onto an image sensor in the form of a charge coupled device array that generates luminescent symbol image information. The optical apparatus 24 is in communication with the processor 22 via a universal serial bus (USB) 23, however a network in the form of a Wi-Fi network, a Bluetooth network or generally any suitable form of communications network may be used. Both the optical apparatus 24 and the processor 22 are configured to be connected to the universal serial bus 23, each having a USB interface, and in use are connected to the universal serial bus via their USB interface. The optical apparatus 24 may alternatively or additionally be in communication with the processor 22 via an internetwork (e.g. comprising at least two of Bluetooth, Wi-Fi, Ethernet, a PAN, a LAN, a WAN, and ATM, and the Internet). Alternatively, the optical reader 24 and the processor 22 may be connected by a point-to-point connection (i.e. the optical apparatus 24 is a peripheral to the processor 20), for example via a serial cable or null-modem cable. In another embodiment, however, the optical symbol reader 24 may be a hand-held unit that comprises both the processor 22 and the optical apparatus 24. Luminescent symbol image information processing program instructions run on the processor 22 retrieves the object identifier from the luminescent symbol image information.

The optical symbol reader 20 is generally but not necessarily for exclusive use by an authority that binds the information to the tangible object. For example, the authority may be an organisation that generates and/or controls the information, or an individual or business that bought the reader for—generally but not necessarily—exclusive use. Examples of such authorities include a government, a passport issuing authority, an educational institution an example of which includes but is not limited to a university, a pharmaceutical manufacturer, an engineering material manufacturer, a notary, a legal practitioner, a property register, and a device certifier.

The public key derivation algorithm used is based on the eliptic curve secp256k1 in the elliptic curve digital signature algorithm (ESCDA) library, however it may use generally any suitable form of public-key encryption algorithm, for example an integer factorization algorithm, and a discrete logarithm algorithm. In the present but not necessarily all embodiments, the public key is processed with a hash function in the form of SHA256, the output of which is still considered to be a public key, however now disguised to reduce the likelihood of successfully recovering the original private key, especially in the case of realisation of a quantum computer which may allow a public key to be converted back to the private key. Only the disguised public key may be distributed publically, which may be secure against quantum computing.

The public key information, the information bound to the object, and the digital signature are associated in a data store 30 in the form of a computer database or block chain node controlled by the authority. Generally, but not necessarily, the data store 30 is remote to the optical symbol reader 20, for example within the other processor 28 in communication with the processor 22 via an internetwork in the form of the Internet. The public key information is sent by the processor 22 to the other processor 28 over a network 32 or internetwork to which the remote server is connected to. The information is also sent to the other processor 28 by the processor 22, or otherwise entered into it (e.g. via a server user interface). The digital signature is also sent to the remote server by the processor 22.

The other processor 28 is generally but not necessarily controlled by the authority or at least has control of an account on the server 28. The server 28 may be a virtual server, for example an AWS EC2. For example, the information bound to the object, the digital signature information and the public key information may be stored in the same database record or block of a block chain. Document based databases may be used, where information is stored in structures such as JSON type structures. The information bound to the tangible object can be retrieved using the public key information (which may be stored and used in either its original form or its disguised form). The digital signature can be retrieved using the public key information.

The public key information is in the present but not all embodiments associated with public key information metadata, for example error correction information (e.g. check sum sequence), and version information. The public key information and the public key information may be integrated, for example within the payload of a protocol data unit (e.g. a TCP segment, UDP packet or other protocol data unit).

Information bound to the object may be applied—by the authority or their agent for example—to the object. Non-exhaustive examples of the application of information to tangible objects include:
Educational grades may be applied to a piece of paper having a symbol fixed thereto to make a grade certificate;
A blank passport having a symbol fixed to it may have identify information printed to it to make a passport;
A pharmaceutical expiry date may be printed to a package having a symbol fixed thereto to complete a pharmaceutical package;
A device having a symbol fixed to it may have the information transferred to it from transfer paper; and
Specifications may be engraved into a piece of engineering steel or an ammunition shell, for example, has a symbol attached to it.

While the information is applied to the above examples tangible objects, the information bound to a tangible object may not be applied to the tangible object. The information bound to the tangible object may be separated from the tangible object, for example in a computer data store.

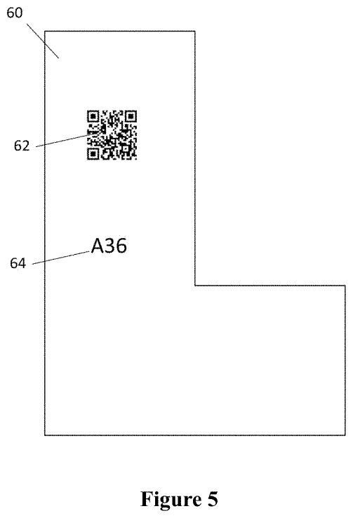

Similarly, the public key (which is generally, but not necessarily the disguised form), may be applied to the tangible object. FIG. 5 shows an example of a piece of engineering steel 60 with a representation 62 of the public key information, and digital signature information in the form of a QR code applied thereto. A sequence of digits, a bar code, or other suitable form may be used instead of the QR code. Optionally, a representation 64 of the information is bound to the object 60 (in this example information indicating that the engineering steel is a structural steel commonly used in the US).

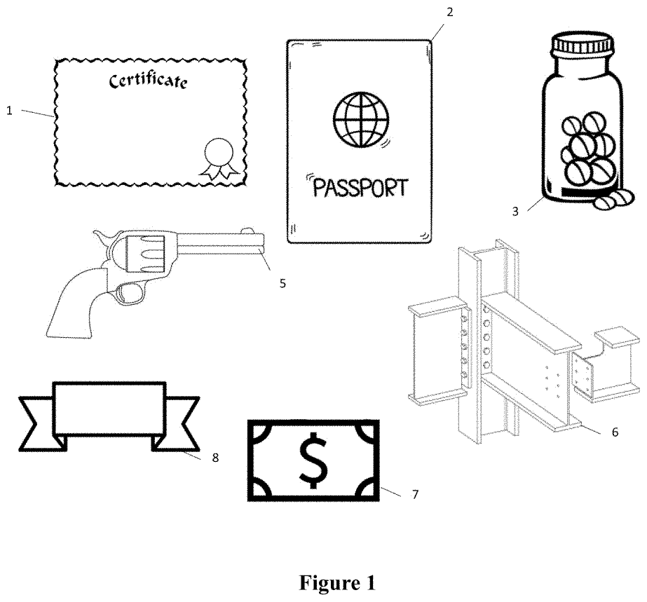

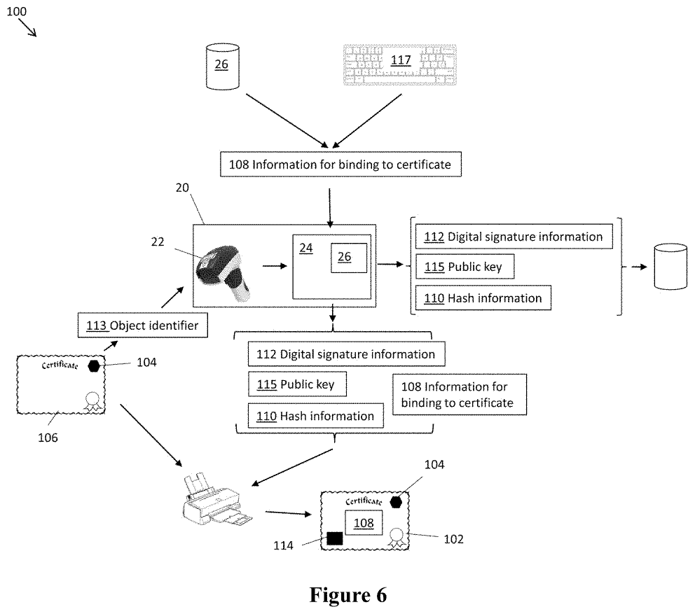

FIG. 6 shows a block diagram 100 of an example of binding information to a paper based value document in the form of a university transcript 102, where parts similar and/or identical in form and/or function to those in FIGS. 1 to 5 are similarly numbered. A piece of transcript stationary 106 in the form of a piece of paper has printed onto it a symbol 104 in the form of a luminescent symbol. The symbol 104 is read with a symbol reader 20 to extract the object identifier 113 encoded in the symbol 104. The symbol reader 20 generates a public key 115 (which uniquely identifies the transcript) with a key derivation algorithm, the object identifier 113 and the authority identifier stored in processor tangible storage media 26. The transcript information 108 is extracted from a data store 112 in a student information data base within a computer server. The transcript information may be consistently structured so that hash information generated by processing the transcript information is consistent. Alternatively, the transcript information 108 is keyed in using a keyboard 117 or received by other methods and/or apparatus. The transcript information 108 is processed by a hash algorithm in the form of SHA256, and the resulting hash information 110 is processed by a digital signature algorithm in the form of ECDSA sign recoverable (part of the ECSDA library) run on the processor 24 to generate a digital signature information 112 of the hash information 110. The hash algorithm may be applied to a Merkle tree comprising the structured information. The purpose of the Merkle Tree may include:
To generate a root hash which is an organised fingerprint of all the information;
Information is organised according to rules;
Another entity using the same rules will obtain the same root hash;
The structure enables determining which specific data field modified without needing to query all the original information.

Using a printer 114 in the form of a laser, inkjet or dot matrix printer for example, the transcript information 108 is printed onto the transcript stationary 106. The digital signature information 112, the public key information 115 and the hash information 110 is also printed on the transcript stationary, generally but not necessarily encoded into a machine readable representation 114 comprising a QR code, however a barcode, a sequence of machine readable symbols or generally any suitable representation may be used. The digital signature information 112, the public key information 115 and the hash information 110 is stored in data store 28. The transcript information printed on the transcript stationary 106 and the information stored in the database 28 is tamper evident and bound together.

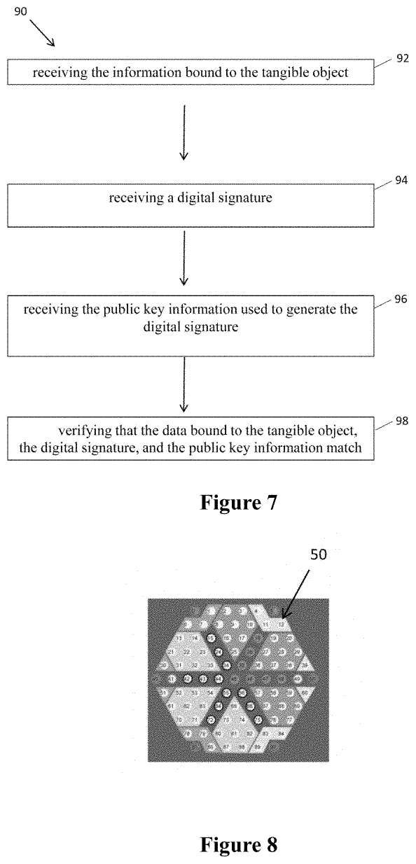

FIG. 7 shows a flow chart 90 showing steps of an embodiment of a method for verifying information bound to a tangible object. A step 92 comprises receiving the information bound to the tangible object which may comprise hash information. A step 94 comprises receiving a digital signature generated as described above, or by generally any suitable method. A step 96 comprises receiving the public key information used to generate the digital signature. The public key may be re-derived by reading the optical symbol. Alternatively, the public key may be recovered from a QR code (another optical symbol) on the tangible object. A step 98 comprises verifying that the data bound to the tangible object, the digital signature, and the public key information match, with for example a digital signature verification algorithm. Embodiments may verify the information bound to the object, the source of the information bound to the object (e.g. the authority) and the object associated with the information. This may be done by inference. If the re-derived public key matches the public key recovered using the ECDSA recover public key algorithm and the signature information, then this infers that the information was signed by a private key and that the private key was derived from the paring of the object identifier (and hence the object) and the authority identifier. The signature information could not have been created using any other private key, therefore the information is bound to the object identifier (and hence the tangible object).

In an example, an authority may provide an app that can run on any suitable processor, for example a smart phone or general purpose computer, available to a person in the form of an authority officer. The person can enter into the app, for example type, the information bound to the object and applied to the object or a part thereof. Only a hash of the information applied to the object or part thereof may be sent by the app, not the actual information, which may prevent others from illicitly obtaining the information. Alternatively, the authority may provide a web interface to the server for entering the information bound to the object, the public key information, and the digital signature information. The digital signature may either recovered from the server or recovered from a machine readable code such as a QR code affixed to the object. The public key can be recovered from the machine readable (QR) code. If the person only entered a limited set of data fields, the remaining information or its hash may be recovered from the server or QR code. Verification may be generally performed by the App, which prevents a server with malicious or fraudulent intent, for example, providing a false verification. This acceptance or rejection may be indicated to the person, for example by use of colour or other graphical elements, sound, or by displaying the “rejected” or “accepted” or the like. The verification will fail if:
the information either in the data store or on the object is tampered with;
the digital signature information is tampered with or wrong;
the public key information is tampered with or wrong.

The bound information when applied to the object may be captured by taking a digital photograph and the information extracted from the digital image.

The grade certificate 102, for example, may be verified. A person may use a verification application or app running on a smart phone, tablet computer or other computational device and a symbol reader 20 to read the symbol 104 and derive the public key information. If the person did not have access to the symbol reader 20, they may use a verification application or app to scan the QR-code 114 on the certificate 102 to recover the public key information. The public key information is used to query a data store for the digital signature and the certificate information and/or hash information. Optionally, the person may manually type in only some of the information such as the name and the grade point average on the certificate 102. The information is structured according to predefined rules into a Merkle tree, for calculating a root hash. The output of the verification process would be indicated to the person on a human machine interface (e.g. screen, speaker, LED etc.). Generally, the digital signature may be retrieved from a data store, which may be the tangible object itself with the digital signature encoded in a QR code or other form encoded on the tangible object. Alternatively, the digital signature may be on packaging for the tangible object, an authority server, or a public block chain.

An authority—for example a computer server in the authority's possession—may receive a message indicating that a symbol fixed to a tangible object has been read by an optical symbol reader in its possession. In the context of this document, the meaning of possession encompasses:
knowing of its presence and has physical control of it; or
has the power and intention to control it.

A non-exclusive example of such an authority is a passport authority that possesses a plurality of optical symbol readers at a plurality of ports. The message may be sent, for example, when an optical symbol on a passport is optically read during the holder's transit through one of the plurality of ports. The message is indicative of optical reading of the symbol fixed to the tangible object has been read, and generally comprises the public key information (which is a unique ID for the tangible object, and which is also exclusive to the paring of the authority identifier and the object identifier) generated on reading of the symbol. The message may comprise only the public key, although it will generally comprise more information, for example the network address of the optical reader that sent the message. The authority may wish to confirm, however, that the symbol fixed to the tangible object was indeed optically read by the optical reader, and has not been merely received a replay of an early sent—that is a malicious “replay attack” by a “man-in-the-middle”. The replay may be to misrepresent the holder of the passport as having transited a port—for example—and may be generally indicative of criminal activity. Similar confirmation may be desired in the optical scanning of a symbol fixed to engineering steel at a worksite, a symbol fixed to an ammunition shell at a barrack or station, or generally any suitable tangible object as required.

An embodiment of a method for verifying that an optical symbol fixed to a tangible object was optically read is now described. The embodiment of the method comprises the steps of:
with an optical symbol reader having preloaded therein an authority identifier indicative of the authority providing the information, retrieving an object identifier indicative of the identity of the tangible object by optically reading a symbol fixed to the tangible object and encoding the object identifier;
within the optical reader, generating private key information with a key derivation algorithm, the object identifier and the authority identifier, the private key information being exclusive to the pairing of the authority identifier and the object identifier;
within the optical reader, generating public key information with a public key derivation algorithm and the private key information, the public key information being exclusive to the pairing of the authority identifier and the object identifier;
sending a message indicative of the symbol having been optically read and comprising the public key information to a server;
authenticating the message indicative of the symbol having been optically read with cryptographic challenge-response authentication using the private key information and the public key information.

The message indicative of the symbol having been optically read is generally, but not necessarily, sent to a processor in the form of a computer server, a virtual computer server, personal computer, or block chain node. The processor may be in the possession of the authority and comprise program instructions which when executed by a processor causes the processor to participate in the cryptographic challenge-response authentication. The processor confirms that the received public key corresponds to an object represented within its database. The processor generates challenge information in the form of at least one randomly selected symbol (e.g. a single symbol in the form of a numerical digit or a sequence of symbols in the form of a string of digits). The processor sends the challenge information to the optical symbol reader. The optical symbol reader compiles metadata about the reading event, for example time at reading, location information such as global navigation satellite system location information, additional user inputs, purpose of scan etc. The metadata may be structured with the received random sequence and public key information, for example using a Merkle tree method. The root hash of the data is calculated. Digital signature information for the root-hash information is generated using the derived private-key and an ECDSA digital signature algorithm. The information and the corresponding digital signature information is sent to the processor. The processor creates the same data structure using the received data, the public key and its copy of the at least one randomly selected symbol. The server generates root-hash information. The root hash information and the public key is used by the processor to verify that the digital signature using the ECDSA verification method. Generally, any suitable cryptographic challenge-response authentication using the private key information and the public key information may be used.

Consequently, the processor has confirmed that the optical symbol on a tangible object was optically read by an optical reader in possession of the private key. The only probable way for the optical reader to create the digital signature is for the symbol reader 20 to have generated the private key information from the optical symbol at the time the optical symbol was read by the optical symbol. The use of a different random sequence of symbols for each optical reading prevents replay attacks. If the at least one symbol was not randomly selected, the information and digital signature may be intercepted and the same information may be replayed again to falsely claim that the same optical symbol had been optically read again.

Luminescent Symbols

FIG. 8 shows a schematic diagram representing the structure of an example symbol in the form of a luminescent symbol 100. The luminescent symbol 100 comprise a plurality of cells comprising at least one luminescent material. The plurality of cells encode information at least in part by their arrangement. The plurality of cells are disposed at selected prearranged points of a plurality of prearranged points to at least in part encodes the represented information. The plurality of prearranged points provide a fixed structure that can be used for a plurality of luminescent symbols.

Each of the plurality of cells comprises a luminescent dot comprising a crystalline upconversion material comprising a plurality of rare earth doped upconversion particles and a polymer matrix. That is, the luminescence material comprises a fluorescent material. The plurality of rare earth doped upconversion particles may each have a largest dimension in the range 0.1 μm-100 μm across, however other embodiments may have smaller or larger particles. The polymer matrix may be formed by curing a resin with an actinic light (for example, curing with an ultraviolet light the resin CPS 1040 UV manufactured by Sigma-Aldrich). The plurality of rare earth doped upconversion particles are suspended in the resin and printed using a piezo inkjet print head. The applicants have determined that the plurality of rare earth doped upconversion particles each have a largest dimension in the range of 0.01 μm-0.5 μm to enable printing by an inkjet print head and provide sufficient luminescence, or generally any feasible available inkjet print head. Generally, any suitable alternative process may be used, for example a bubble jet or screen printing process. In another example, a metal part may be pot peen marked forming a plurality of cavities which may be filled with the rare earth doped upconversion particles to complete the luminescent symbol. In yet another example, the luminescent symbol is printed to a hot stamp label or a transfer film, and then applied from the label or film to the tangible object. When printed on a tangible object, the luminescent symbol is fixed to a tangible object. For example, when printed on a tangible object comprising paper (e.g. a piece of paper or cardboard), the resin may penetrate the paper and bind with the fibers to become integral with the paper. This may make it harder to tamper with the luminescent symbol. The tangible object may be a metallic machine part, a piece of material used in the building or other industry, packaging or generally any tangible object compatible with the luminescent material. A material in the form of a transparent coating may be applied to the tangible object over the luminescent symbol 100, which may provide extra protection and embed the luminescent symbol 100.

In alternative embodiments, the plurality of cells may comprise upconversion nanoparticles, for example rare earth doped upconversion nanoparticles produced by Sigma-Aldrich, or an organic upconversion material, for example a polycyclicaromatic hydrocarbon, or quantum dots suspended in a suitable liquid in the form of, for example, toluene. Generally, any suitable luminescent material may be used. In some examples otherwise identical to the luminescent symbols 100, the at least one luminescent material comprises at least two luminescent materials and the information is encoded with a radix greater than 2 using the at least two luminescent materials. For example, one luminescent material may emit green light, and another luminescent material may emit red light. Each of the plurality of cells may comprise either one of or both of the two luminescent materials. More than two luminescence materials may be used to encode information with a radix greater than three.

The arrangement of a plurality of luminescent elements 100 in the luminescent symbol 50 is optically readable. In a step of an embodiment of a method for reading the luminescent symbol 50, the luminescent symbol 50 is illuminated with a luminescent cell exciting radiation in the form of a laser beam emitted by the optical apparatus 24 that causes the plurality of luminescent elements 100 to luminesce, that is emit luminescent light (photoluminesce). In a step of the embodiment of the method for reading the luminescent symbol, the luminescing plurality of elements are digitally imaged by the optical apparatus 24 and the information encoded is extracted from the digital image by the processor 22. The processor includes program instructions that when executed causes the processor to detect the presence or absence of luminescence at each of a plurality of positions whereby the object identifier is extracted. When the illumination of the luminescent symbol ceases, the luminescence emitted by the luminescence symbol decays to nothing, such that the luminescent symbol emits no light.

Luminescence may be isolated from the excitation source using synchronous detection, whereby a camera (e.g. comprising a CCD device and an optical imaging device operationally coupled thereto) is controlled to capture an image of the luminescence after the excitation laser pulse is switched off. A short image capture time (“fast shutter speed”) may reduce the effect of background light being detected. Two images may be taken. The first may be timed to capture the luminescence, and the second may be timed so that the luminescence has at least significantly decayed, if not stopped altogether.

Tangible Objects

Examples of tangible objects and information bound to them include, but are not limited to the following:
A land title certificate, comprising land ownership information, land specification information, and land identification information. In some jurisdictions a land title certificiate may validate claims of ownership.
Drivers licenses and identification cards, which may comprise person identification information, address information, date of birth information and expiry data information.
A police check report, which comprises criminal history information.
A pharmaceutical foil, which may comprise pharmaceutical information, date of manufacture information, expiry data information, and pharmaceutical regulatory information.
Product packaging, to which supply chain information is bound. An optical reader may optical read the optical symbol at each of a plurality of points within a supply chain, and metadata added at each optical reading event.

Now that embodiments have been described, it will be appreciated that some embodiments have some of the following advantages:
Information can be bound to an object.
The information bound to the object can be authenticated.
Tampering with either the symbol fixed to the object or the information bound to the object is detectable.
Information associated with a symbol reading event, for example reading event metadata, can be confirmed.
A reading event can be confirmed. It may not be possible to deny that a reading event occurred at a later date because the act of digitally signing creates a state of non-repudiation.
Unlike barcodes, a luminescent symbol may be difficult to forge or alter and are very difficult to copy and read without specialised equipment. Security may be provided by the difficulty in forging the luminescent symbol, preferably such that forging the optical symbol is not practical.
The authority identifier, which may be a cryptographically secure random number, may be difficult to acquire, which may secure the information. There is a low probability of guessing the authority identifier.
The symbol can be relatively cheaply applied (compared for example with RFID and integrated circuits in credit cards) and the binding process is inexpensive.

Variations and/or modifications may be made to the embodiments described without departing from the spirit or ambit of the invention. For example, the symbol may not be a luminescent symbol, but may be some other form of readable symbol for example a bar code or a QR code. While the algorithms described herein include a readily available public key crytopgraphic algorithm, a readily available digital signature algorithms and a readily available digital signature verification algorithm, unique or specialised algorithms may be used. While embodiments disclose authorities in the form of large organisations such as governments and educational institutions, an authority may be an individual, a business organisation, a charity or generally any person or organisation that issues information. The authority and the issuer of the information for binding to an object may not be the same. For example, the authority may be a public notary and the issuer may be a university. The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A method for binding information to a tangible object, the method comprising:
retrieving an object identifier indicative of an identity of the tangible object by optically reading, with an optical symbol reader having preloaded therein an authority identifier indicative of an authority providing the information, a symbol fixed to the tangible object and encoding the object identifier;
generating private key information with a key derivation algorithm, the object identifier and the authority identifier, the private key information being exclusive to the pairing of the authority identifier and the object identifier;
generating public key information with a public key derivation algorithm and the private key information, the public key information being exclusive to the pairing of the authority identifier and the object identifier; and
generating digital signature information for the information with a digital signature generation algorithm and the public key information; and
sending the public key information, the digital signature information and the information to a data store, whereby the public key information, the digital signature information and the information is associated therein.

2. A method defined by claim 1 comprising processing authority provided information with a hash function to generate the information.

3. A method defined by claim 1 comprising the step of associating the public key information, the information bound to the object and the digital signature in a data store.

4. A method defined by claim 1 comprising the step of sending the public key information to an authority associated with the optical symbol reader.

5. A method defined by claim 1 wherein the public key derivation algorithm uses elliptic curve cryptography.

6. A method defined by claim 1 wherein the public key derivation algorithm comprises a hash algorithm.

7. A method defined by claim 1 wherein the public key information is associated with public key information metadata.

8. A method defined by claim 1 comprising applying to the object the information bound to the object.

9. A method defined by claim 1 wherein the object identifier, and authority identifier each comprises a respective sequence of symbols.

10. A method defined by claim 1 wherein the optical symbol reader comprises a processor and optical apparatus in communication with the processor, wherein the key derivation algorithm is executed in the processor.

11. A method defined by claim 1 wherein the optical symbol reader is a peripheral.

12. A method defined by claim 1 wherein the symbol comprises a luminescent symbol.

13. A method defined by claim 1 wherein the symbol is exclusive to the tangible object.

14. A method for verifying information bound to a tangible object, the method comprising:
receiving the information bound to the tangible object;
receiving a digital signature generated by the method defined by claim 1;
receiving the public key information used to generate the digital signature; and
verifying that the data bound to the tangible object, the digital signature, and the public key information match.

15. A method defined by claim 13 comprising capturing the data bound to the tangible object by digital imaging.

16. A method for verifying that an optical symbol fixed to a tangible object was optically read, the method comprising:
with an optical symbol reader having preloaded therein an authority identifier indicative of an authority providing the information, retrieving an object identifier indicative of an identity of the tangible object by optically reading, a symbol fixed to the tangible object and encoding the object identifier;
within the optical symbol reader, generating private key information with a key derivation algorithm, the object identifier and the authority identifier, the private key information being exclusive to the pairing of the authority identifier and the object identifier;
within the optical symbol reader, generating public key information with a public key derivation algorithm and the private key information, the public key information being exclusive to the pairing of the authority identifier and the object identifier;
sending a message indicative of the symbol having been optically read and comprising the public key information to a server;
authenticating the message indicative of the symbol having been optically read with cryptographic challenge-response authentication using the private key information and the public key information.

17. A system for binding information to a tangible object, the system comprising:
an optical symbol reader comprising:
an optical apparatus configured to generate symbol image information by imaging a symbol encoding object identifier and fixed to the tangible object; and
a processor comprising memory having preloaded therein an authority identifier and configured to:
receive the symbol image information and retrieve the object identifier from the symbol image information so imaged;
combine the object identifier and the authority identifier with a key derivation algorithm and so generate private key information that is exclusive to the pairing of the authority identifier and the object identifier;
generate public key information with a public key derivation algorithm and the private key information, the public key information being exclusive to the pairing of the authority identifier and the object identifier; and
generate digital signature information for the information with a digital signature generation algorithm and the public key information; and
send the public key information, the digital signature information and the information to a data store, whereby the public key information, the digital signature information and the information is associated therein.

18. (canceled)
